(19) United States
(12) Patent Application Publication
(10) Pub. No.: US 2026/0233254 A1
(43) Pub. Date: Aug. 13, 2026

(54) METHOD FOR HANDLING AT LEAST ONE TARGET PIECE GOOD AND DEVICE FOR HANDLING AT LEASE ONE TARGET PIECE GOOD

(71) Applicant: Körber Supply Chain Logistics GmbH, Konstanz (DE)

(72) Inventors: Marco Fischer, Konstanz (DE); Rolf-Peter Skrdlant, Überlingen (DE); Dirk-Udo Eisser, Reichenau (DE); Richard Huber, Konstanz (DE); Oliver Schulze, Überlingen (DE)

(21) Appl. No.: 19/181,915

(22) Filed: Apr. 17, 2025

(30) Foreign Application Priority Data
Apr. 19, 2024 (DE) 10 2024 110 999.8

(51) Int. Cl. B07C 5/02

(52) U.S. Cl. CPC B07C 5/02; B07C 2501/0063

(57) ABSTRACT

A method for handling at least one target piece good in the case of a separation of the at least one target piece good from a multiplicity of piece goods where the at least one target piece good rests directly or indirectly on a contact surface includes displacing the at least one target piece good via a handling device, where during the displacement a force acts between the target piece good and the handling device and a force acts between the target piece good and the contact surface. Furthermore, a device for handling at least one target piece good in the case of a separation of the at least one target piece good from a plurality of piece goods is provided.

### BACKGROUND OF THE INVENTION

The present invention relates to a method for handling at least one target piece good, in particular in the case of the separation of at least one target piece good from a large number of piece goods, and to a device for handling at least one target piece good, in particular in the case of the separation of at least one target piece good from a large number of piece goods.

Piece goods, in particular various types of postal piece goods or mailings, are often arranged in bulk, i.e. as a 2D or 3D heap, during processing, for example during transport for subsequent sorting. This is a problem for sorting, because these piece goods typically have to be separated for this purpose, on the one hand to be able to read and assign certain piece good information, and on the other hand to be able to handle the piece goods individually for further processing. It is known that the piece goods can be separated by manual handling. However, this requires a considerable amount of personnel and is often time-consuming. It is often difficult to separate individual piece goods from the multitude of piece goods by machine, and this often results in damage to the piece goods. In particular, with heavy piece goods and piece goods with packaging that is not very resilient, it is a challenge to separate them from the other piece goods by machine. For example, it is known to use a vacuum to attach to the top side of the piece good and to lift the piece good against the direction of the force of gravity. However, this can be problematic if the piece good is particularly heavy or is arranged in packaging that has a very low load-bearing capacity or tear resistance. Therefore, mechanical handling of the piece goods can often result in damage to them.

State-of-the-art mechanical handling systems are often complicated and take up a lot of space (for example, inclined roller conveyors with a downstream singulator).

Therefore, one of the objects of the present invention is to provide a solution for the mechanical handling of piece goods that is less complicated and can be arranged in a space-saving manner.

### SUMMARY OF THE INVENTION

According to one aspect of the present invention, a method is provided for handling at least one target piece good, in particular during the separation of the at least one target piece good from a plurality of piece goods. The at least one target piece good is preferably in direct or indirect contact with a contact surface. The method can comprise a displacement of the at least one target piece good by means of a handling device. During the displacement, a force preferably acts between the target piece good and the handling device and a force between the target piece good and the contact surface.

Compared to the known state of the art, the present invention offers the advantage that the piece good being moved remains in contact with the contact surface during the movement. This means that it is not necessary for the target piece good to be completely lifted by the handling device. This allows the target piece good to transfer at least part of its mass via the contact surface. Therefore, a force between the target piece good and the handling device can be reduced. This can prevent damage to the target piece goods. Target piece goods must be removed from a bulk of piece goods for separation. In order not to have to overcome gravity and to have to grip the target piece goods firmly in order to lift them, the target piece goods can be removed from the bulk by horizontal displacement in a plane. This can prevent the packaging of the target piece goods or the target piece goods themselves from being destroyed or damaged by the handling device gripping them too firmly. Furthermore, less energy is required to operate the handling device because it does not have to overcome the entire weight of the target piece goods in order to handle them.

Separation can be a conversion of a two-dimensional or three-dimensional arrangement of piece goods into a one-dimensional arrangement of the piece goods. The piece goods to be separated can be at rest or in motion. Furthermore, separation can also be a precise placement or positioning of a piece good. For example, separation is necessary before a piece good is placed on a sorter. Furthermore, separation may be necessary if a piece good is to be individually recognized and/or handled. The piece good may be a postal piece good or postal package such as a small package, a parcel, a small, a polybag, a mailing tube, a mailing bag or the like. A piece good may have a variety of different outer shapes. Furthermore, piece goods can have a wide variety of outer packaging, making it difficult to always handle a piece good optimally according to its requirements. The contact surface can be a surface on which one or more piece goods rest. The contact surface can be a collection point where piece goods are collected. The contact surface can, for example, be an essentially horizontal plane provided at an unloading point, at the end of a chute, at the end of a conveyor belt or similar. A piece good can be in direct contact with the contact surface if it makes direct contact with the contact surface. There may be indirect contact if, for example, the piece good rests on another piece good, which in turn rests on the contact surface. Thus, the piece good can also be indirectly on the contact surface (i.e. indirectly). In any case, the piece good can introduce at least part of its weight (i.e. the force resulting from the mass of the piece good together with the acceleration due to gravity) into the contact surface. This introduction can be direct or indirect via other piece goods or other objects. The displacement of at least one piece good can be a repositioning and/or reorientation of the target piece good. This can separate the target piece good from other piece goods. Separating can mean here that the target piece good is spaced from other piece goods. The handling device can be a device designed to manipulate a piece good. Preferably, the handling device is a gripping device that can grip a piece good in such a way that it can displace the piece good. Additionally, or alternatively, the gripping device can be a device that can displace the piece good. When the target piece good is being moved by the handling device, a first force can act between the handling device and the target piece good and a second force between the target piece good and the contact surface. Both forces can be non-zero. For example, if the target piece good is merely lifted by a handling device, only a single force acts, namely between the target piece good and the handling device. In one aspect of the present invention, the fact that two forces are present, namely between the target piece good and the handling device and between the target piece good and the contact surface, means that it is not necessary for the force between the target piece good and the handling device to be excessively large. This allows the force to be chosen so as to avoid damaging the target piece good during displacement. In other words, the handling device can push the target piece good along the contact surface when the target piece good is moved. The target piece good does not have to rest directly on the contact surface. Rather, it is sufficient that there is a force between the target piece good and the contact surface, where this force is not equal to 0. This means, for example, that a weight force of the target piece good can be at least partially transferred via the contact surface. This does not have to be applied directly and immediately to the contact surface, but can also be applied indirectly, for example via another piece good or other devices in the contact surface. The only important thing is that a force acts on the target piece good at two points that are spaced apart from each other. This avoids a force peak of a single force and thus prevents damage to the target piece good. Furthermore, this can increase the efficiency of the transfer of the target piece good.

Preferably, the method further comprises detecting or acquiring at least one piece of information about the target piece of goods. Preferably, the method further comprises detecting or acquiring at least one piece of information about the target piece of goods and identifying the at least one target piece of goods to be relocated based on the at least one piece of information. The at least one piece good information can be indicative of a property of the target piece good. Furthermore, the at least one piece good information can also include information about a position, arrangement, orientation of the adjacent piece goods. In other words, the target piece good can be surrounded by a plurality of other piece goods, whereby this circumstance can be included in the at least one piece good information of the target piece good. A property of the target piece good may, for example, be a mass of the target piece good, an external shape of the target piece good, a surface texture of the target piece good or the like. The at least one piece of information can be recorded, preferably immediately before the relocation. The detection can be realized, for example, by a sensor device. In other words, the detection can mean that the at least one piece of information is detected (i.e. determined) individually for the target piece of goods to be moved. Furthermore, the at least one piece of information can also be obtained. In other words, in this case the piece of information cannot be detected, but can be obtained (e.g. transferred) from another device. This is advantageous, for example, if the piece good has already been manipulated by another handling system before it is handled, whereby the at least one piece good information has been recorded. Thus, in the present handling method, the need to re-record the at least one piece good information can be avoided, and instead, existing data (i.e. piece good information) can be accessed. This simplifies and accelerates the handling process.

Preferably, the method also includes identifying the at least one target piece good that is to be relocated. If a plurality of piece goods are provided, a target piece good can be identified from the plurality of piece goods. The target piece good can then be the piece good that is to be relocated next. Preferably, such a piece good is positioned so that it can be easily relocated. The step of identifying can, for example, include identifying the location of the target piece good. For example, if a piece good is located at the edge of a heap of piece goods, this piece good can be identified as the target piece good because it can be easily relocated. Furthermore, piece goods that are at the top (in the direction of heaviness) can be identified as target piece goods, since these can be gripped and thus moved without any problems.

Preferably, the at least one piece good information includes a form of the target piece good, a position of the target piece good, an arrangement of piece goods adjacent to the target piece good, a mass of the target piece good, a nature of the target piece good and/or a distance of the target piece good from the contact surface. The form of the target piece good can, for example, be indicative of a geometric form of the target piece good. The target piece good can, for example, have a rectangular, cylindrical or otherwise disposed geometry. The piece good information can be used to determine how and/or where the target piece good can best be contacted in order to realize the relocation. The position of the target piece good can be indicative of an orientation of the target piece good in space. The arrangement of the piece goods adjacent to the target piece good can indicate whether the target piece good can be easily relocated or whether the target piece good is blocked by one or more other piece goods. The mass of the target piece good can be indicative of the weight of the target piece good. The nature of the target piece good can be indicative of an external nature of the target piece good. For example, the texture may be indicative of a material surrounding the target piece goods. This can help to draw conclusions about how the target piece goods can be moved. For example, the material can have an influence on which gripping device can be used to grasp the piece goods. For example, the air permeability of a packaging of the target piece goods plays a role when it is grasped by means of a vacuum gripping device.

Preferably, more than one target piece good is identified. Preferably, more than one target piece good is relocated with the handling device. This can increase efficiency, since, for example, several target piece goods can be relocated simultaneously. It is conceivable that target piece goods are pushed to a conveyor belt and can be transported away one after the other. In this way, several target piece goods can be handled (i.e. moved) by the handling device and yet a separation of the piece goods can be achieved.

Preferably, the relocation is carried out based on the at least one piece good information. In other words, the relocation of the target piece good can also be adapted to the properties of the target piece good. This means that the relocation can be carried out particularly gently. For example, the acceleration during the transfer of the target piece good can be adjusted. In this way, a compact and solid target piece good (e.g. a small package) can be transferred faster than, for example, a flexible and formable target piece good (e.g. a polybag). This adapted handling can increase efficiency.

Preferably, the target piece goods are identified based on a position and/or orientation of the target piece goods on the contact surface. Preferably, the method comprises identifying the at least one target piece good to be relocated based on the at least one piece good information. For example, it may matter where the piece good lies on the contact surface. For example, if the piece good is particularly close to a destination (e.g. a sorter or output location) for the piece good, this piece good can be identified as the destination piece good, since relocation is minimized. This means that relocation can be carried out very efficiently.

Preferably, the method further comprises uncovering the target piece good from the plurality of piece goods. For example, a target piece good to be relocated next may be surrounded by other piece goods such that the target piece good cannot be readily relocated by the handling device. In such a case, the piece goods surrounding and thus blocking the target piece good can be relocated first. This relocation can then be a relocation that merely clears a certain area so that the target piece good can be easily relocated by the handling device. It is conceivable that the target piece good is buried under a multitude of other piece goods, and that the handling device clears away the other piece goods before moving the target piece good, so that the handling device can easily reach the target piece good. This makes it possible to relocate a desired or individually determined target piece good even from a bulk of piece goods. The relocation of at least one piece good in the context of the uncovering can be carried out analogously to the relocation of the target piece good. This means that this relocation can also be realized efficiently. In the following, the relocation of the target piece good is usually discussed with regard to relocation, but the same applies analogously to the relocation of other piece goods from the multitude of piece goods.

Preferably, the displacing is a physical displacing. In other words, during the displacing, a piece good can be moved from a first position to a second position, wherein the first position is not equal to the second position. The physical displacing can involve a spatial change of position.

Preferably, the displacing involves pushing and/or shoving the at least one target piece good. The handling device can thus be designed to displace the target piece good in a desired direction by the handling device contacting and displacing the target piece good. In this case, the handling device does not have to grasp the target piece good. This can prevent damage to the target piece good. For example, very fragile piece goods can be handled without any problems. Furthermore, the handling device can be designed to be particularly simple, since it only has to be able to move the target piece good.

Preferably, the displacement is essentially orthogonal to the direction of gravity. In other words, the target piece goods can be displaced over the contact surface at an angle of essentially 90°(±10°) to the direction of gravity. This can ensure that a weight force, which the piece good exerts in the direction of the heaviness on a substrate (i.e. the contact surface), is satisfactorily removed by the contact surface. This can reduce the force that exists between the target piece good and the handling device.

Preferably, the at least one target piece good is at least indirectly in contact with the contact surface during the displacement. In other words, the target piece good does not have to be in direct contact with the contact surface, but can be in indirect contact with the contact surface, for example, via other piece goods or other devices such as chutes, ramps or the like. What is important is that the target piece good can, for example, introduce a weight force into the contact surface. This ensures that the force between the target piece good and the handling device is minimized. However, the target piece good is not transported over the contact surface by a transport device or the like.

Preferably, the target piece good is moved parallel to the contact surface during the relocation. In this case, the contact surface can be aligned essentially orthogonal to the direction of the center of gravity. This can ensure that a weight force exerted by the target piece good in the direction of the center of gravity is transferred through the contact surface.

Preferably, the contact surface is designed as a flat surface. In this context, “flat” can mean that the contact surface is designed as a constant surface (i.e. without recesses). The contact surface is preferably aligned orthogonally to the direction of the force of gravity. The contact surface is preferably oriented horizontally. This can ensure that a weight force exerted by the target piece good can be satisfactorily applied to the contact surface.

Preferably, the contact surface is designed as a roller table. The roller table can have a plurality of rollers with which the piece goods located on it are in contact. This can minimize friction between the contact surface and the target piece good during a transfer of the target piece good. As a result, the force acting on the target piece good can be further reduced, thus avoiding damage to the target piece good. In other words, friction between the target piece good and the contact surface can be reduced.

Preferably, the at least one target piece good is stored in a stream of piece goods by the displacement. A piece good stream can be, for example, a stream of piece goods on a sorter. The present method can, for example, be arranged in front of a high-speed injection. This allows a piece good to be fed individually (i.e. singly or singularly) to the high-speed injection so that the high-speed injection can easily shoot the piece good onto the sorter. Furthermore, the piece good stream can also be any other piece good stream (preferably a piece good stream that has already been separated) into which the target piece good is to be introduced. To put it more precisely, it is conceivable that the target piece good, which is separated by the present process, can then be fed into any handling process where the presence of a separated piece good is important.

Preferably, at least one piece good is arranged in a bulk of piece goods. A bulk of piece goods can, for example, be a fill of piece goods. It is conceivable that a large number of piece goods are supplied to the process as a bulk. A bulk is created, for example, by tipping a load of piece goods onto a contact surface. This can result in a two-dimensional heap or a three-dimensional heap. The present method is then able to separate the piece goods by shifting target piece goods.

Preferably, at least one target piece good is at rest before being moved. In other words, the plurality of piece goods to be separated by the present method can be present in a stationary arrangement. In other words, the handling device can move the at least one target piece good away from a poured heap of piece goods.

Preferably, the at least one target piece good is held by a frictional connection and/or a form-fit during the transfer. A form-fit can be present when the target piece good is pushed through the handling device. This can prevent the target piece good from moving away from the handling device. A frictional connection or a force-locked connection can occur between the target piece good and the handling device if static friction between the target piece good and the handling device is greater than static friction between the target piece good and a surface on which the target piece good is placed (e.g. the contact surface). This can prevent an excessive point force from being applied to the target piece good by the handling device, so that damage to the target piece good can be prevented even more reliably.

Preferably, a pushing force or a pulling force acts on the target piece goods from only one side during the transfer. In other words, the target piece goods can either be pushed or pulled. Thus, it is not necessary to grasp or otherwise hold the target piece goods. This helps to prevent damage to the target piece goods.

Preferably, the capturing of at least one piece of information about the piece goods is realized by means of a recognition system. The recognition system can be a vision system that optically records information. The recorded information can then be processed to obtain the at least one piece good information. Preferably, the recognition system can be optical sensors that can record image information about a piece good and, based on this, can determine the at least one piece good information.

Preferably, the recognition system is arranged diagonally above the target piece good. In other words, the detection system can be directed from above (i.e. in an ISO view) onto the at least one piece good and/or the contact surface. This can ensure that a three-dimensional arrangement, orientation and/or position of the at least one piece good can be satisfactorily detected by the detection system.

Preferably, the target piece good is held by a mechanical or pneumatic force during the relocation. A mechanical force can be exerted on the target piece good, for example, by gripping elements. This allows the target piece good to be held particularly securely. A mechanical gripping element can be, for example, a tong-like function end of the handling device. A pneumatic force can be exerted on the target piece goods, for example, by a vacuum suction cup in order to grip them.

The handling device preferably comprises a robot arm. The robot arm can be designed as a manipulator. The robot arm preferably has four axles and four degrees of freedom. All axles can be designed as serial kinematics. In other words, a coordinate origin can be dependent on a position of the previous one. This allows the robot arm to move to any position in the room. Alternatively, the target piece good can be easily approached and then moved. This is possible even if the target piece good is surrounded by other piece goods or there are other obstacles in the way.

According to a further aspect of the present invention, a device is provided for handling at least one target piece good, in particular in the case of a separation of the at least one target piece good from a multiplicity of piece goods. The at least one target piece good rests directly or indirectly on a contact surface. Preferably, the device comprises a handling device that is designed to displace a piece good. The device preferably includes a control unit that is designed to control the handling device in such a way that the target piece good is moved in such a way that a force acts between the target piece good and the handling device and a force acts between the target piece good and the contact surface. The device can preferably be arranged upstream of a sorting device. This can ensure that piece goods are only fed to the sorting device individually. The device can also include the contact surface. The contact surface is preferably designed so that it has a low coefficient of friction between a piece good and the surface of the contact surface. This can prevent high frictional forces from occurring between the piece good and the contact surface when piece goods are moved over the contact surface, which could cause damage to the piece good.

Preferably, the handling device comprises at least one gripping device, in particular at least one suction cup. The suction cup can be impacted by vacuum in order to suck on and hold a piece good. Furthermore, it is conceivable that the gripping device can also be designed as a mechanical gripping device. For example, the mechanical gripping device can be a pincer-like device designed to grip piece goods individually or together.

Preferably, the handling device comprises a pressure section designed to exert a pressure force on a piece good. The pressure section can comprise a surface that can contact a piece good to be displaced. The pressure section can be designed in a slider-like manner so that a piece good can be displaced with the pressure section. The pressure section can be designed to only exert a pressure force on a piece good. In other words, the pressure section cannot exert any force on a piece good other than a pressure force. This makes it easy to displace a piece good.

Preferably, the handling device comprises at least one protruding element that can come into contact with the piece good. The protruding element can, for example, be a projection that can contact at least one piece good. It is conceivable, for example, that the protruding element is designed as a pin-like projection. Thus, piece goods that are present in a two-dimensional or three-dimensional arrangement can be removed (e.g. pushed out) from such an arrangement in a targeted manner. For example, a target piece good surrounded by a multitude of other piece goods can be pushed out by the protruding element in a targeted manner, for example in order to relocate it or to be able to grasp it. This means that a target piece good can be efficiently removed from a bulk arrangement.

Preferably, a plurality of protruding elements are provided, which are designed to be movable relative to each other. In other words, the protruding elements can be designed and arranged to match the target piece goods to be displaced. For example, if the target piece goods are very small (i.e. have a very small surface area), only one protruding element can be used to contact these target piece goods. If the target piece goods are larger (i.e. have a larger surface area), several protruding elements can be used to displace the target piece goods. This ensures that a small target piece goods can be contacted satisfactorily and that a large target piece goods is not damaged by a single protruding element.

Preferably, each protruding element is telescopically movable. In other words, the at least one protruding element can be moved back and forth. In this case, telescopic can mean that the at least one telescopic element is at least partially telescoped in the retracted state. This allows the at least one protruding element to be designed in a particularly space-saving way. As a result, the handling device can be advantageously compact.

Preferably, the pressure section has a variable pressure surface that is designed to come into direct contact with a piece good. In other words, a pressure surface with which the handling device can displace the target piece good can be designed to adapt to the target piece good. More specifically, it is conceivable that the pressure surface can increase or decrease its area to adapt to the target piece goods. This allows the target piece goods to be optimally relocated without damaging them. Furthermore, even if the piece goods are arranged very close together on the contact surface, a single piece good (for example the target piece good) can be efficiently picked out and relocated. The pressure surface can be varied, for example, by a variable element. It is conceivable that the pressure surface has a revolver mechanism with which the pressure surface can be varied. This ensures that the pressure surface of the handling device can be individually adapted to the target piece goods.

Preferably, the contact surface is designed to be movable. In other words, it is conceivable that the contact surface can rotate around a vertical axle. The vertical axle can extend along the direction of the center of gravity. Furthermore, the contact surface can be displaced along a linear axle. In this way, with a stationary handling device, the piece goods can be oriented and/or turned relative to the handling device so that the target piece good can be efficiently relocated. Furthermore, this allows for a predetermined order in which the piece goods are to be separated. In addition, a larger extension of piece goods can be handled by a single handling device. In other words, the piece goods can be brought into a handling area of the handling device in order to be moved there by the handling device. In addition, by rotating the contact surface, the piece goods to be moved next can be aligned with the handling device so that it can move the piece goods.

Preferably, the control unit is designed to handle at least one target piece good based on a predetermined order. In other words, the piece goods that are moved by the handling device can be determined by an order so that the separated piece goods have a predetermined order.

Preferably, the handling device has a restraint device that is designed to prevent piece goods that are not to be relocated from being relocated. In other words, the restraint device can be provided on the handling device to hold back other piece goods on which the target piece good can exert a force during a relocation. The restraining device can thereby exert compressive forces on other piece goods in order to counteract their displacement. This can ensure that only the target piece good is displaced without the other piece goods being displaced. This can, for example, prevent the other piece goods from tipping over unintentionally. Furthermore, it can prevent piece goods that are not supposed to be relocated from falling off the contact surface.

Preferably, the restraint device and the pressure section are designed to be movable relative to each other. For example, the pressure section can be moved to cover or shield the gripping device at least to one side. The pressure section can be made of rubber, for example. This protects the gripping device, which is preferably designed as a vacuum gripping device. This can prevent the gripping device from being damaged when the handling device moves and comes into contact with other elements. Furthermore, the pressure section can be used as a stop for a target piece to be gripped. In other words, the target piece can be gripped by the gripping device and moved up to the pressure section until the target piece is in contact with the pressure section. The contact between the pressure section and the target piece goods can be used to define a position of the target piece goods. This can be used to prevent, for example, a piece good from being sucked too far into the vacuum gripping device when the gripping device is designed as a vacuum gripping device. This can protect the vacuum gripping device and also prevent damage to the target piece good. The printing section can be arranged around the gripping device. For example, the printing section can be moved relative to the gripping device so that the gripping device cannot be contacted by piece goods. This means that the handling device can be used to move piece goods. For example, it is conceivable that in the case of a three-dimensional heap of piece goods, the handling device is moved to push away an upper layer of piece goods in order to reach a specific target piece good. The target piece good can then be grasped by a gripping device and moved.

The handling device is preferably designed to displace a target piece good while another target piece good is held by the handling device. In other words, the handling device can, for example, pick up and thereby hold and/or displace a target piece good while the handling device displaces or pulls another piece good. This means that the individual movements of the handling device can be used efficiently to simultaneously displace and/or hold several piece goods. This can increase the overall efficiency of the device. Furthermore, it is conceivable that a relocation path for the target piece good is selected so that it is minimized. To do this, it may be necessary to push other piece goods out of the way. This can increase the efficiency of the overall system, since it is not necessary to move around other piece goods, but other piece goods can be pushed away in order to reach the shortest path to a desired storage location. Furthermore, it is conceivable that the handling device, when relocating a first target piece good, simultaneously uncovers a second target piece good to be relocated, by pushing or pushing away piece goods during the relocation of the first target piece good. This means that every movement of the handling device can be used.

According to one aspect of the present invention, the displacement (e.g. the shifting) can be realized in principle as pushing away from a handling device or pushing towards a handling device. In both cases, however, it can be a matter of pushing, whereby a pushing force acts as a compressive force from one side on the piece good. However, pushing can also be done by pulling, in which case the pushing force acts as a pulling force on the piece good. In all cases, however, only one force is required to overcome the friction between the piece good and its contact surface and/or other piece goods. Typically, however, no force is needed to lift the piece good against gravity.

The optional recognition system can be directed not only from above but also laterally onto the piece goods (i.e. onto the contact surface) in order to provide target sizes/input data for the relocation of the target piece goods (i.e. the piece goods information). A sequence in which the target piece good is relocated can depend not only on whether the target piece good is on top or particularly easy to access, but in particular on whether the target piece good is lying at the front and can therefore be handled first, because the target piece good can be moved horizontally for extraction without colliding with other piece goods. In addition, numerous other aspects can be taken into account during relocation, such as whether piece goods are lying on top of each other, what size the piece goods are, and whether pushing and exerting a compressive force can be grasped behind them, because the necessary clearance for the handling device to enter and make contact next to a piece good must be available. This can provide optimization potential, for example, to first push aside the target piece goods or other piece goods in unfavorable arrangement constellations before the actual relocation of the target piece goods takes place.

A handling device can be understood to mean a displacement device that can be positioned at a suitable point on/next to a piece good in order to exert a compressive force on the piece good during its subsequent displacement by an actuator (e.g. a robot arm) in order to displace it and thus remove it from the bulk of a large number of piece goods. However, pushing can also be done by pulling (for example, as with a vacuum-impacted suction cup). It can be defined in individual cases whether pushing or pulling is used to extract the target piece good. This can be done, for example, based on the at least one piece good information. Thus, different elements can be combined on a handling device, i.e. those that push and those that pull, in order to be able to realize the best force application on a piece good and the best path for its removal for all arrangements of the piece goods. A pushing element (i.e. the handling device) can, in the simplest case, have a constant geometry or size. For example, the handling device can be designed like a rake. However, the handling device can be variable in shape and size in order to be optimally used depending on the size of the piece goods and the available storage space for positioning the handling device. For example, several retractable and extendable pins can be provided to make contact with the target piece goods. The extendable and retractable pins can be varied in their extension path and/or number in order to be able to realize efficient contact with the target piece good without damaging it. The contact surface on which the piece goods rest can have a low coefficient of friction in order to minimize the required displacement forces. Preferably, the contact surface can be provided with roller elements. For example, the contact surface can be designed as a ball carpet. In principle, a piece good can be moved in such a way that it then comes to rest on another transport system, in order to be transported further by this individual system.

For example, a target piece good can be pushed onto a sorter using the handling device. The target piece good cannot be lifted in the process. The weight of the target piece good is therefore less relevant. The transfer of the target piece good could take place on a metal plate or a roller table. This can reduce the space required for a transfer process.

Another aspect of the present invention provides for the use of the above method and/or device in the separation of piece goods.

Some of the features and embodiments mentioned above can be combined with other features and other embodiments to form new embodiments. Advantages and developments mentioned in combination with the features or embodiments also apply analogously to the new embodiments. Furthermore, advantages and developments mentioned in connection with the process also apply to the device and vice versa.

### BRIEF DESCRIPTION OF THE DRAWINGS

The present invention will be described in detail below with reference to the figures.

FIG. 1 is a schematic and perspective view of a device for handling at least one target piece goods according to one embodiment of the present invention;

FIG. 2 is an enlarged, schematic and perspective view of a target piece good during a relocation according to one embodiment of the present invention;

FIG. 3 is a schematic view of a detail of a handling device according to one embodiment of the present invention; and

FIG. 4 is a schematic flow chart of a method according to the embodiment of the present invention.

### DETAILED DESCRIPTION OF THE PREFERRED EMBODIMENTS

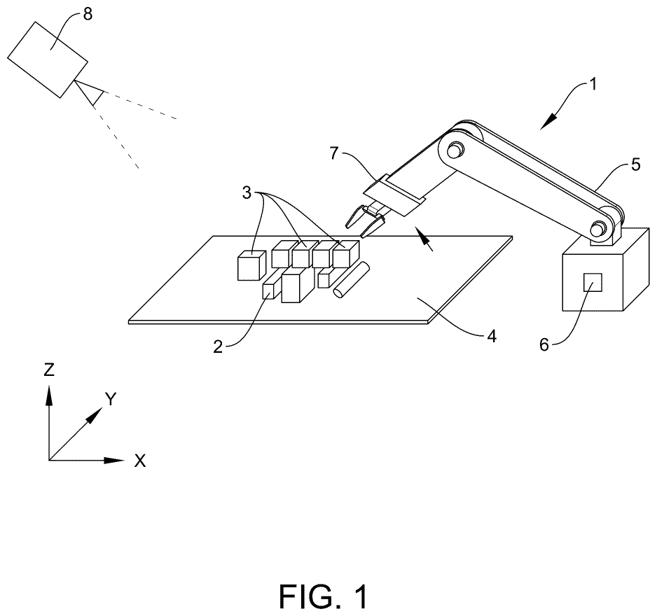

FIG. 1 is a schematic and perspective view of a device 1 for handling at least one target piece good 2. A plurality of piece goods 2, 3 rest on a contact surface 4. The piece goods can be arranged arbitrarily in a two-dimensional or three-dimensional arrangement on the contact surface 4. Therefore, the piece goods 2, 3 can also be arranged on top of each other. The piece goods 2, 3 can, for example, be present in a described order. The piece goods 2, 3 can be any type of piece goods, in particular postal piece goods. Furthermore, the device 1 comprises a handling device 5. The handling device is designed to displace a target piece good 2. The target piece good 2 is one of the plurality of piece goods 3. The handling device has an end effector 7 that is designed to come into contact with the target piece good 2. The handling device 5 can move the target piece good 2 in such a way that a force is exerted from the target piece good 2 on the handling device 5 and on the contact surface 4. In other words, the target piece good can be pushed over the contact surface 4 without it being necessary to lift the target piece good 2 in the vertical direction (Z-direction). Furthermore, the device 1 of the present embodiment has a recognition system 8 that is designed to capture at least one piece good information of the piece goods 2, 3. The piece good information includes a position of a piece good, an arrangement of piece goods adjacent to the target piece good, a mass of the target piece good, a nature of the target piece good and/or a distance of the target piece good from the contact surface. This allows the control unit 6 to decide which piece good is to be gripped by the handling device 5 in order to be moved.

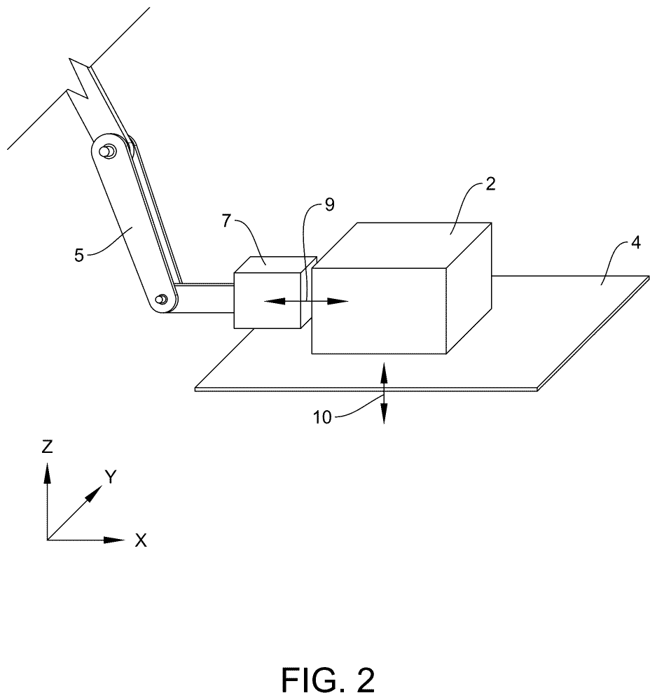

FIG. 2 is a schematic and perspective view of a target piece good 2 that is moved over the contact surface 4 by a handling device 5. It can be seen that the target piece good exerts a first force 9 on the handling device (more precisely, on the end effector 7) and a second force 10 on the contact surface 4. The first force 9 pushes the target piece good 2 over the contact surface 4. The second force 10 is a weight force of the target piece good, which is introduced into the contact surface 4.

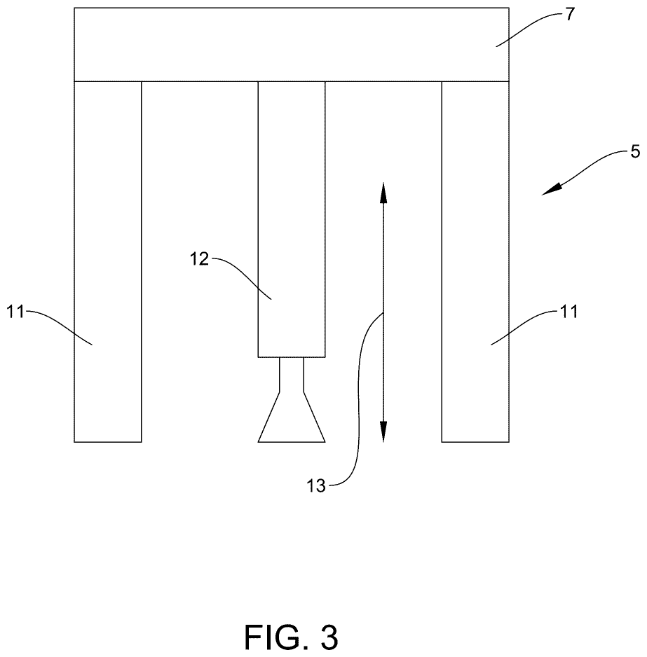

FIG. 3 is a schematic view of a detail of the handling device 5. More specifically, FIG. 3 shows the end effector 7 in detail. The end effector 7 has a gripping device 12 and pressure sections 11, each adjacent to the gripping device 12, in the present embodiment. The gripping device of the present embodiment is designed as a suction gripping device. The pressure sections 11, which are arranged on the left and right in FIG. 3 next to the gripping section, are designed to displace a target piece good 2. Furthermore, the pressure section 11 can also be used to move other piece goods out of the way (i.e. to displace them). Furthermore, the pressure sections 11 can also serve as a restraint device. This means that a piece good that is not to be moved can be restrained while a target piece good 2 is being moved. In a further embodiment, not shown, the restraining device is arranged as a separate component on the end effector 7 of the handling device 5. In the present embodiment, the pressure sections 11 can be moved relative to one another and relative to the gripping device 12. More specifically, the pressure sections can be moved back and forth in the direction 13. This allows the gripping device 12 to be uncovered or to be protected by the printing sections so that the gripping device is not exposed. This helps to protect the gripping device.

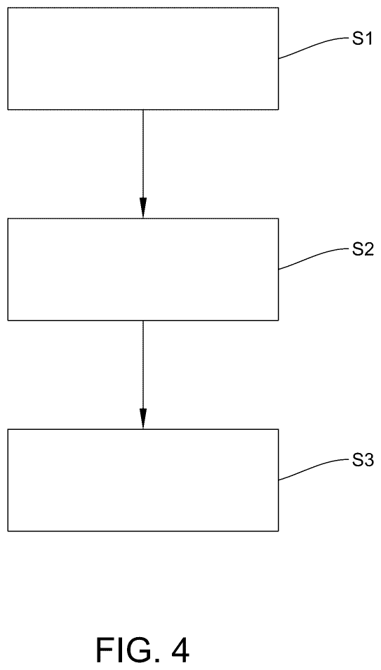

FIG. 4 is a schematic flow chart showing the course of a process according to one embodiment of the present invention. In step S1, at least one piece good information of a target piece good is acquired or obtained. Thereby, characteristics of a potential target piece good can be acquired. In step S2, the at least one target piece good can then be identified based on the at least one piece good information. If the at least one target piece good 2 is identified, in step S3 the at least one target piece good can be relocated as described above. The relocation can be carried out based on the at least one piece good information.

### REFERENCE SIGN LIST

1 Device

2 Target piece good

3 Piece good

4 Contact surface

5 Handling device

6 Control unit

7 End effector

8 Recognition system

9 First force

10 Second force

11 Pressure sections

12 Gripping device

13 Direction

The invention claimed is:

1. A method for handling at least one target piece good in the case of a separation of the at least one target piece good from a plurality of piece goods, wherein the at least one target piece good rests directly or indirectly on a contact surface, comprising:
displacing the at least one target piece good via a handling device, with a force acting between the target piece good and the handling device and a force acting between the target piece good and the contact surface during the displacement.

2. The method according to claim 1, further comprising:
detecting or acquiring at least one piece of information of the target piece.

3. The method according to claim 2, further comprising:
uncovering the target piece good from the plurality of piece goods.

4. The method according to claim 3, wherein the at least one target piece good is held by a frictional and/or a form fit during the displacement.

5. The method according to claim 4, wherein the target piece goods are held by a mechanical or pneumatic force during the displacement.

6. The method according to claim 1, further comprising:
uncovering the target piece good from the plurality of piece goods.

7. The method according to claim 1, wherein the at least one target piece good is held by a frictional and/or a form fit during the displacement.

8. The method according to claim 1, wherein the target piece goods are held by a mechanical or pneumatic force during the displacement.

9. A device for handling at least one target piece good in the case of a separation of the at least one target piece good from a plurality of piece goods, wherein the at least one target piece good rests directly or indirectly on a contact surface, comprising:
a handling device configured to displace a piece good; and
a control unit configured to control the handling device such that the target piece good is displaced such that a force acts between the target piece good and the handling device and a force acts between the target piece good and the contact surface.

10. The device according to claim 9, wherein the handling device comprises at least one gripping device.

11. The device according to claim 10, wherein the at least one gripping device includes a suction cup.

12. The device according to claim 7, wherein the handling device comprises at least one protruding element that can come into contact with the piece good.

13. The device according to claim 12, wherein the contact surface is configured to be movable.

14. The device according to claim 13, wherein the handling device has a retaining device that is configured to prevent piece goods that are not to be relocated from being relocated.

15. The device according to claim 9, wherein the handling device comprises at least one protruding element that can come into contact with the piece good.

16. The device according to claim 9, wherein the contact surface is configured to be movable.

17. The device according to claim 9, wherein the handling device has a retaining device that is configured to prevent piece goods that are not to be relocated from being relocated.
